(19) United States
(12) Patent Application Publication
(10) Pub. No.: US 2025/0063459 A1
(43) Pub. Date: Feb. 20, 2025

(54) HANDLING CONDITIONAL HANDOVER

(71) Applicant: Nokia Technologies Oy, Espoo (FI)

(72) Inventors: Xin ZHANG, Taufkirchen (DE); Umur KARABULUT, Munich (DE); Jani-Pekka KAINULAINEN, Cottenham (GB); Halit Murat GÜRSU, Munich (DE); Riikka Karoliina DIMNIK, Kirkkonummi (FI)

(21) Appl. No.: 18/807,324

(22) Filed: Aug. 16, 2024

Related U.S. Application Data
(60) Provisional application No. 63/520,419, filed on Aug. 18, 2023.

(51) Int. Cl. H04W 36/36; H04W 36/00; H04W 74/0833

(52) U.S. Cl. CPC H04W 36/362; H04W 36/0083; H04W 74/0833

(57) ABSTRACT

Example embodiments of the present disclosure relate to a solution for handling a conditional handover. In this solution, the first apparatus, receives, from a second apparatus, configuration information indicating: a first conditional cell change configuration associated with a first candidate cell of the first apparatus, and a second conditional cell change configuration associated with a second candidate cell of the first apparatus; and in accordance with a determination that a first condition for switching to the first candidate cell is met, continues to evaluate a second condition for switching to the second candidate cell within a period, wherein the first apparatus is served by a first serving cell and a second serving cell.

### FIELD

Various example embodiments of the present disclosure generally relate to the field of telecommunication and in particular, to methods, devices, apparatuses and computer readable storage medium for handling conditional handover.

### BACKGROUND

Dual Connectivity (DC) is a mode of operation where a terminal device (for example, user equipment, UE) can be configured to utilize radio resources provided by two network nodes. A first network node serves the terminal device as a Master Node (MN), and a second network node serves the terminal device as a Secondary Node (SN). The MN and SN may be deployed at a same network device (also called as intra-gNB sometimes) or the MN and SN may be deployed at two different network devices (also called as inter-gNB sometimes).

Due to the moving of the UE and the deterioration of the communication condition, the UE may need to switch to new cell(s), and sometimes may need to transition from a DC mode to a single connectivity. Compared with the single connectivity, DC may achieve a higher throughput and reliability. Thus, how to avoid an improper transition from the DC mode to the single connectivity is desirable to be further discussed.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, configuration information indicating: a first conditional cell change configuration associated with a first candidate cell of the first apparatus, and a second conditional cell change configuration associated with a second candidate cell of the first apparatus; and in accordance with a determination that a first condition for switching to the first candidate cell is met, continue to evaluate a second condition for switching to the second candidate cell within a period, wherein the first apparatus is served by a first serving cell and a second serving cell.

In a second aspect of the present disclosure, there is provided a second apparatus. The second apparatus comprises at least one processor; and at least one memory storing instructions that, when executed by the at least one processor, cause the second apparatus at least to: transmit, to a first apparatus served by a first serving cell and a second serving cell, configuration information indicating: a first conditional cell change configuration associated with a first candidate cell of the first apparatus, and a second conditional cell change configuration associated with a second candidate cell of the first apparatus, wherein the configuration information further indicates at least one of the following: an indication indicating that the first apparatus is allowed to continue to evaluate a second condition after a first condition is met, the first condition being used for switching to the first candidate cell and the second condition being used for switching to the second candidate cell, a time length of a period, wherein the first apparatus continues to evaluate the second condition within the period after the first condition is met, or a threshold quality, wherein the first apparatus continues to evaluate the second condition within the period after the first condition is met if a communication quality of the second serving cell is below the threshold quality.

In a third aspect of the present disclosure, there is provided a method. The method comprises: receiving, at a first apparatus and from a second apparatus, configuration information indicating: a first conditional cell change configuration associated with a first candidate cell of the first apparatus, and a second conditional cell change configuration associated with a second candidate cell of the first apparatus; and in accordance with a determination that a first condition for switching to the first candidate cell is met, continuing to evaluate a second condition for switching to the second candidate cell within a period, wherein the first apparatus is served by a first serving cell and a second serving cell.

In a fourth aspect of the present disclosure, there is provided a method. The method comprises: transmitting, at a second apparatus and to a first apparatus served by a first serving cell and a second serving cell, configuration information indicating: a first conditional cell change configuration associated with a first candidate cell of the first apparatus, and a second conditional cell change configuration associated with a second candidate cell of the first apparatus, wherein the configuration information further indicates at least one of the following: an indication indicating that the first apparatus is allowed to continue to evaluate a second condition after a first condition is met, the first condition being used for switching to the first candidate cell and the second condition being used for switching to the second candidate cell, a time length of a period, wherein the first apparatus continues to evaluate the second condition within the period after the first condition is met, or a threshold quality, wherein the first apparatus continues to evaluate the second condition within the period after the first condition is met if a communication quality of the second serving cell is below the threshold quality.

In a fifth aspect of the present disclosure, there is provided a first apparatus. The first apparatus comprises means for receiving, from a second apparatus, configuration information indicating: a first conditional cell change configuration associated with a first candidate cell of the first apparatus, and a second conditional cell change configuration associated with a second candidate cell of the first apparatus; and means for in accordance with a determination that a first condition for switching to the first candidate cell is met, continuing to evaluate a second condition for switching to the second candidate cell within a period, wherein the first apparatus is served by a first serving cell and a second serving cell.

In a sixth aspect of the present disclosure, there is provided a second apparatus. The second apparatus comprises means for transmitting, to a first apparatus served by a first serving cell and a second serving cell, configuration information indicating: a first conditional cell change configuration associated with a first candidate cell of the first apparatus, and a second conditional cell change configuration associated with a second candidate cell of the first apparatus, wherein the configuration information further indicates at least one of the following: an indication indicating that the first apparatus is allowed to continue to evaluate a second condition after a first condition is met, the first condition being used for switching to the first candidate cell and the second condition being used for switching to the second candidate cell, a time length of a period, wherein the first apparatus continues to evaluate the second condition within the period after the first condition is met, or a threshold quality, wherein the first apparatus continues to evaluate the second condition within the period after the first condition is met if a communication quality of the second serving cell is below the threshold quality.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates an example timeline for handling conditional handover;

FIG. 3A illustrates a signaling chart for communication according to some example embodiments of the present disclosure;

FIG. 3B illustrates an example timeline for handling conditional handover according to some example embodiments of the present disclosure;

FIG. 4 illustrates a signaling chart for communication according to some example embodiments of the present disclosure;

FIG. 5 illustrates another signaling chart for communication according to some example embodiments of the present disclosure;

FIG. 6 illustrates a flowchart of a method implemented at a second apparatus according to some example embodiments of the present disclosure;

FIG. 7 illustrates a flowchart of a method implemented at a second apparatus according to some example embodiments of the present disclosure;

FIG. 8 illustrates a simplified block diagram of a device that is suitable for implementing example embodiments of the present disclosure; and

FIG. 9 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), enhanced machine type communication (eMTC) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

In Release 17, Conditional HandOver (CHO) in Multi-Radio Dual Connectivity (MR-DC) is limited to the scenario where the target MN can prepare a single target Primary Secondary Cell (PSCell) (under the control of an SN). This limits the usefulness of the CHO MR-DC feature where UE may need to access different target PSCell when the CHO needs to be executed.

Thus, mechanisms for CHO in MR-DC where target MN can prepare multiple target PSCells for the same target PCell needs to be further studied. For example, taking CHO including target Master Cell Group (MCG) and target Secondary Cell Group (SCG) as the baseline, CHO including target MCG and candidate SCGs for Conditional PSCell Change (CPC)/Conditional PSCell Addition (CPA) (CPAC) in NR-DC may be further studied.

In summary, the UE may be provided with a configuration consist of both CHO and CPAC configurations, i.e., UE will conditionally handover to both PCell and PSCell, considering the execution conditions of each cell given in the handover configuration.

It has been agreed to support the simultaneous evaluation of CHO and CPC.

According to this agreement, the UE should not need to unpack any of the nested conditional configuration containers in order to measure.

In case that the UE is configured with both CHO and CPC configurations, when both CHO and CPC conditions are met, both CHO and CPC procedures are executed. In some embodiments, the UE is required to wait until both CHO and CPC conditions are met (always). Furthermore, it is assumed that if needed the network may provide a complementary CHO-only configuration, to avoid failures in deployments where failure would otherwise be likely to happen.

Alternatively, in some embodiments, when CHO condition is met, but CPC condition is not met, CHO execution is triggered (and somehow source SCG may be released). Specifically, when the CHO execution condition is met but no CPC execution condition is met, if there is an available CHO-only or Rel-17 CHO with SCG configuration for which the CHO condition is met, the UE performs the CHO-only or Rel-17 CHO with SCG execution, and thus the network can handle such situation by providing proper configurations.

In some embodiments, the CHO configuration may include target MCG and target SCG in NR-DC and the UE may be configured with one PCell CHO condition, without PScell condition, though UE is expected to perform PCell handover with PScell. In this event, once the execution condition for PCell CHO is fulfilled, the UE may apply the configuration for PCell and PScell and transmit the respective preamble to each RAN node and send the RRC Reconfiguration Complete to the master node.

In some embodiments, the CHO configuration may include target MCG and candidate SCG for CPC/CPA in NR-DC, and the network will configure multiple PCell CHO conditions and multiple candidate PSCell CPC conditions in a mix and matched manner and their corresponding cell configuration to UE via RRC message. In this event, the UE will then monitor both CHO condition and CPAC condition to trigger handover.

Below is the handover delay which is denoted as D_{handover} for conditional handover in perspective of RAN4. Specifically, when the UE receives an RRC message implying conditional handover the UE shall be ready to start the transmission of the new uplink Physical Random Access CHannel (PRACH) within D_{handover} seconds from the end of the last TTI containing the RRC command.

$${D}_{handover} = {T}_{RRC} + {T}_{Event\_DU} + {T}_{measure} + {T}_{interrupt} + {T}_{CHO\_execution} .$$

### Where:

T_{RRC} is the RRC procedure delay;
T_{Event_DU} is the delay uncertainty which is the time from when the UE successfully decodes a conditional handover command until a condition exists at the measurement reference point which will trigger the conditional handover;
Tₘₑₐₛᵤᵣₑ is the measurements time;
T_{CHO_execution} is the conditional execution preparation time. It is defined as the UE execution preparation time for conditional handover and starts after UE realizes the condition of CHO is met and identity of the target cell is determined. T_{CHO_execution} can be up to 10 ms; and
Tᵢₙₜₑᵣᵣᵤₚₜ is the interruption time.

Tᵢₙₜₑᵣᵣᵤₚₜ is defined as the time between when the UE starts to execute the conditional handover to the target cell and the time the UE starts transmission of the new PRACH. In the perspective of RAN4, there is a period T_{CHO_execution} before the interruption and after the condition is met when UE prepares for the RACH procedure. This preparation time is not made aware of to RAN2.

That is, from RAN2 perspective, once the condition is met, UE proceeds to execute cell change. However, if the execution of cell change refers to the RACH procedure which causes the interruption time, from the delay component defined in RAN4, this execution does not start immediately in the perspective of RAN4 after the condition is met.

As discussed above, due to the moving of the UE and deterioration of the communication condition, the UE may need to switch to new cell(s), and sometimes may need to transition from a DC mode to a single connectivity. Compared with the single connectivity, DC may achieve a higher throughput and reliability. Thus, how to avoid an improper transition from the DC mode to the single connectivity is desirable to be further discussed.

According to some example embodiments of the present disclosure, there is provided a solution for handing condition handover. In this solution, a first apparatus (such as, a terminal device) is served by a first serving cell and a second serving cell (i.e., in a DC mode). In operation, the first apparatus receives configuration information from a second apparatus (such as, a network device), where configuration information indicates a first conditional cell change configuration associated with a first candidate cell of the first apparatus, and a second conditional cell change configuration associated with a second candidate cell of the first apparatus. Then, in case that a first condition for switching to the first candidate cell is met, the first apparatus continues to evaluate a second condition for switching to the second candidate cell within a period.

In this way, in case that the first apparatus is operated in DC mode, when a conditional handover to a first candidate cell is triggered, the first apparatus would not fall back to a single connectivity immediately. Instead, the first apparatus will continue to evaluate a second condition for switching to the second candidate cell instead. In this way, the first apparatus may continue operating in DC mode and an improper transition from the DC mode to the single connectivity may be avoided thereby.

As used herein, the terms “gap”, “duration”, “period”, “cycle”, “time length”, “window” may be used interchangeably.

As used herein, the terms “target” and “candidate” may be used interchangeably.

As used herein, the terms “source” and “serving” may be used interchangeably.

As used herein, the terms “CPAC”, “CPC” and “CPA” may be used interchangeably.

In the following, a CHO will be used as an example of “a first conditional cell change configuration”, a CPC will be used as an example of “a second conditional cell change configuration”, a PCell will be used as an example of “a first serving cell”, a PSCell will be used as an example of “a second serving cell”, a candidate PCell will be used as an example of “a first candidate cell”, a candidate PSCell will be used as an example of “a second candidate cell”. It is noted that these example embodiments are given only for the purpose of illustration without suggesting any limitations.

It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### EXAMPLE ENVIRONMENT

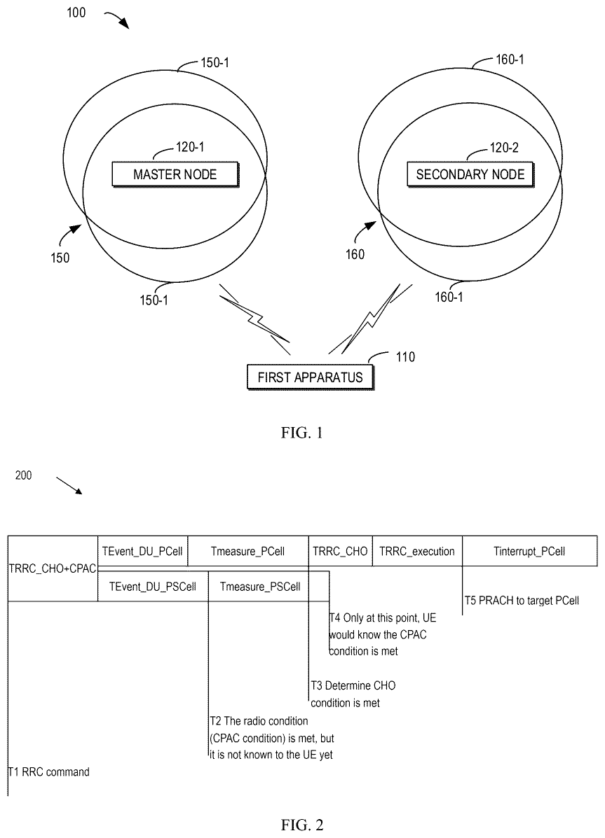

FIG. 1 illustrates an example communication environment 100 in which example embodiments of the present disclosure can be implemented. In the communication environment 100, a plurality of communication devices, including a first apparatus 110, a master node 120-1 and a secondary node 120-2, can communicate with each other.

In the example of FIG. 1, the master node 120-1 and the secondary node 120-2 are serving terminal device 130.

The serving areas of the master node 120-1 and the secondary node 120-2 are called as cells. As shown in FIG. 1, a group of cells of the master node 120-1 includes a primary cell 150-1 and a secondary cell 150-2. Further, the group of cells of the master node 120-1 is referred to as MCG 150 and the primary cell 150-1 is also referred to as PCell 150-1.

A group of cells of the secondary node 120-2 includes a primary cell 160-1 and a secondary cell 160-2. Further, the group of cells of the secondary node 120-2 is referred to as SCG 160 and the primary cell 160-1 is also referred to as PSCell 160-1. The PCell 150-1 and PSCell 160-1 may be collectively referred to as SpCell.

In some example embodiments, the master node 120-1 and the secondary node 120-2 may be deployed at a same network device (also called as intra-gNB sometimes). Alternatively, in some example embodiments, the master node 120-1 and the secondary node 120-2 may be deployed at two different network devices (also called as inter-gNB sometimes).

In the following, for the purpose of illustration, some example embodiments are described with the first apparatus 110 operating as a terminal device and the master node 120-1/the secondary node 120-2 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and the master node 120-1/the secondary node 120-2 is a network device, a link from the master node 120-1/the secondary node 120-2 to the first apparatus 110 is referred to as a downlink (DL), while a link from the first apparatus 110 to the master node 120-1/the secondary node 120-2 is referred to as an uplink (UL). In DL, the master node 120-1/the secondary node 120-2 is a transmitting (TX) device (or a transmitter) and the first apparatus 110 is a receiving (RX) device (or a receiver). In UL, the first apparatus 110 is a TX device (or a transmitter) and the master node 120-1/the secondary node 120-2 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Work Principle and Example Signaling for Communication

Based on the handover delay definition in RAN4, T_{Event_DU} indicates a condition to be existed, but the UE would only know about it through measurement, which is marked by the measurement delay, Tₘₑₐₛᵤᵣₑ. Reference is now made to FIG. 2, which illustrates an example timeline 200 for handling conditional handover.

As illustrated in FIG. 2, upon receiving the RRC configuration from the network, which contains PCell CHO condition, and PSCell CPAC condition, the UE will first decode the RRC message, get the corresponding measurement information, and start measurement on the candidate PCell and PScell.

The UE may determine whether the PCell CHO condition/PSCell CPAC condition is met according to the measurement results. In FIG. 2, the UE may determine the PCell CHO condition is met at the end of T_{measure_PCell} (i.e., T3), and may determine the PSCell CPAC condition is met at the end of T_{measure_PSCell} (i.e., T4).

In the example of FIG. 2, at time point T3, the radio condition for PSCell CPAC condition is already met, but UE is not aware of it (that is because the UE has not measured the SSB of the target cell to realize the PSCell condition has met).

According to RAN2 agreement, when the CHO condition is met, but no PSCell CPAC condition is met, UE will perform CHO-only configuration (additional configuration) or perform Rel-17 CHO with SCG execution if such configuration is provided, which means that the UE will transition from the DC mode to the single connectivity. Further, when performing CHO, the UE will take extra time to decode the extra configuration as marked by T_{RRC-CHO} in FIG. 2 and requires T_{RRC-execution} for preparing the CHO.

The above fallback procedure creates additional decoding time, and causes the UE is switched from dual connectivity to single connectivity which reduces the throughput. Moreover, as the PSCell condition has met actually, the fallback procedure is not the optimal and necessary, and thus it is expected to be avoided. According to the present disclosure, the above improper fallback procedure may be avoided.

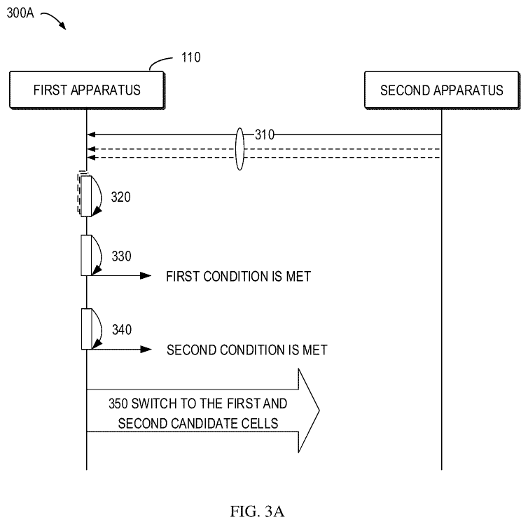

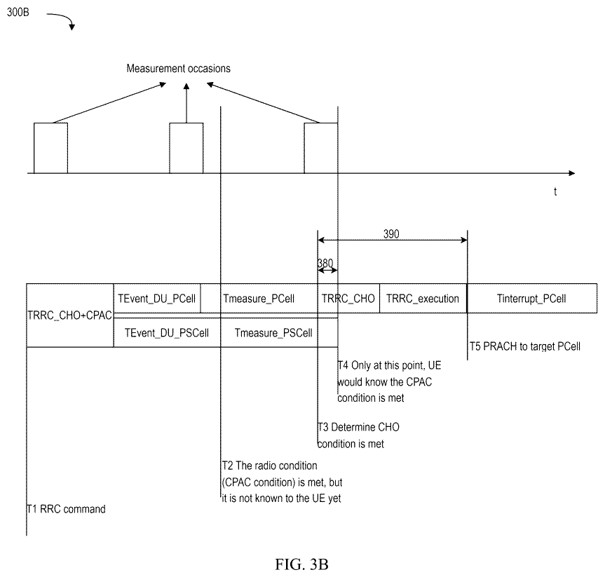

Principles and implementations of the present disclosure will be described in detail below with reference to the FIGS. 3A, 3B, 4 and 5. For the purposes of discussion, example signaling flows in FIGS. 3A, 3B, 4 and 5 will be discussed with reference to FIG. 1, for example, by using the first apparatus 110.

In the example of FIGS. 3A, 3B, 4 and 5, the first apparatus 110 may function as a terminal apparatus. It is to be understood that the operations at the first apparatus 110 and a second apparatus (such as, a network device, which may be a master node or a secondary node) should be coordinated. In other words, the second apparatus and the first apparatus 110 should have common understanding about rules, configurations, parameters and so on. Such common understanding may be implemented by any suitable interactions or by applying the same rule/policy.

In the following, although some operations are described from a perspective of the first apparatus 110, it is to be understood that the corresponding operations should be performed by the second apparatus. Similarly, although some operations are described from a perspective of the second apparatus, it is to be understood that the corresponding operations should be performed by the first apparatus 110. Merely for brevity, some of the same or similar contents are omitted here.

In addition, in the following description, examples of message type (such as “RRC message”, “MAC CE”, “DCI”) are only for the purpose of illustration without suggesting any limitations. In other example embodiments, any suitable message types may be used for the interaction between the first apparatus 110 and the second apparatus.

Reference is now made to FIG. 3A, which illustrates a signaling chart 300A for communication according to some example embodiments of the present disclosure.

In the example of FIG. 3A, the first apparatus 110 may be served by a first serving cell and a second serving cell, i.e., the first apparatus 110 may be operated in a DC mode. Further, in some example embodiments, the first serving cell may be a primary cell (PCell), the second serving cell may be a primary secondary cell (PSCell).

In operation, the first apparatus 110 receives configuration information 310 from a second apparatus (such as, the master node 120-1 or the secondary node 120-2), where the configuration information indicates:
a first conditional cell change configuration associated with a first candidate cell of the first apparatus 110, such as, a CHO configuration, and
a second conditional cell change configuration associated with a second candidate cell of the first apparatus 110, such as, a CPC configuration.

Then, in accordance with a determination that a first condition for switching to the first candidate cell may be met, the first apparatus 110 continues 340 to evaluate a second condition for switching to the second candidate cell within a period.

In some example embodiments, the first candidate cell may be a candidate PCell and the second candidate cell may be a candidate PSCell.

In some embodiments, the first and second conditional cell change configuration (such as, CHO configuration and CPC configuration) may be comprised in an RRC reconfiguration message, which may include MCG configuration and SCG configuration.

In some embodiments, in accordance with a determination that a first condition for switching to the first candidate cell is met, the first apparatus 110 may continue to evaluate the second condition for switching to the second candidate cell within a period before an interruption caused by sending PRACH.

In some example embodiments, the first apparatus 110 may be configured to allow to continue to evaluate the second condition after the first condition. As one example embodiment, continuing to evaluate the second condition after the first condition is defined as a mandatory/default operation by the communication organization (such as 3GPP), or pre-defined by the network operator or service provider. As another example embodiment, the second apparatus that serves the first apparatus 110 may transmit an indication to the first apparatus 110, where the indication indicates that the first apparatus 110 is allowed to continue to evaluate the second condition after the first condition may be met.

In some embodiment, when the first condition is met, the first apparatus 110 may start the CHO preparation to the target cell.

In some example embodiments, in accordance with a determination that the second condition for switching to the second candidate cell is met within the period, the first apparatus 110 may trigger 350 a switch to the first and second candidate cells. In other words, by extending the evaluation time of the second condition after the first condition is met, the first apparatus 110 may continue operating in the DC mode which avoids an improper transition from the DC mode to the single connectivity.

Alternatively, in some example embodiments, in response to the second condition having not been met after the period, the first apparatus 110 may switch to the first candidate cell. In this way, the communication continuity is ensured.

In some example embodiments, whether to extend the evaluation of the second condition after the first condition is met may be performed conditionally, such as, based on the current communication conditions. Specifically, the first apparatus 110 may determine 320 a communication quality of the second candidate candidate cell; and in response to a different between the communication quality and a communication quality required by the second condition of the second serving cell being below a threshold quality, continue to evaluate the second condition.

In some example embodiments, according to the measurement resources (such as, periodic SSB resources), the first apparatus 110 may determine the communication quality of the second candidate cell periodically.

In some embodiments, the threshold quality is pre-defined as a default value (such as, 1 db). As one example, a value of the threshold quality is pre-defined by the communication organization (such as 3GPP), or pre-defined by the network operator or service provider. In this way, a value of the threshold quality may be applied as a default configuration and no additional signaling exchanging is needed.

Alternatively, in some embodiments, a value of the threshold quality may be dynamically or semi-statically configured. For example, be configured by a second apparatus that serves the first apparatus 110 or reported by the first apparatus 110 as a UE capability.

In some example embodiments, a time length of the extended evaluation time period may be limited within a reasonable range. In some example embodiments, the time length of the period may be associated with at least one of the following:
a first time length required for decoding a handover configuration used for switching to the first cell, or
a second time length corresponding to an execution preparation time length for switching to the first cell.

In some embodiments, the time length of the period is pre-defined as a default value. As one example, the at least one rule is pre-defined by the communication organization (such as 3GPP), or pre-defined by the network operator or service provider. In this way, the at least one rule may be applied as a default configuration and no additional signaling exchanging is needed.

Alternatively, in some embodiments, the time length of the period may be dynamically or semi-statically configured. For example, configured by a second apparatus that serves the first apparatus 110 or reported by the first apparatus 110 as a UE capability.

According to the above example processes, the improper fallback to the single connectivity may be avoided. In a nutshell, by stipulating suitable conditions and introducing a time extension for evaluation of PScell, after CHO condition is met, UE shall continue the evaluation of PScell till the end of CHO preparation (i.e., decoding of the target PCell configuration).

Optionally, UE does this evaluation if the Reference Signal Receiving Power (RSRP) of the previous PScell measurement opportunity is 1 dB less than the CPC condition.

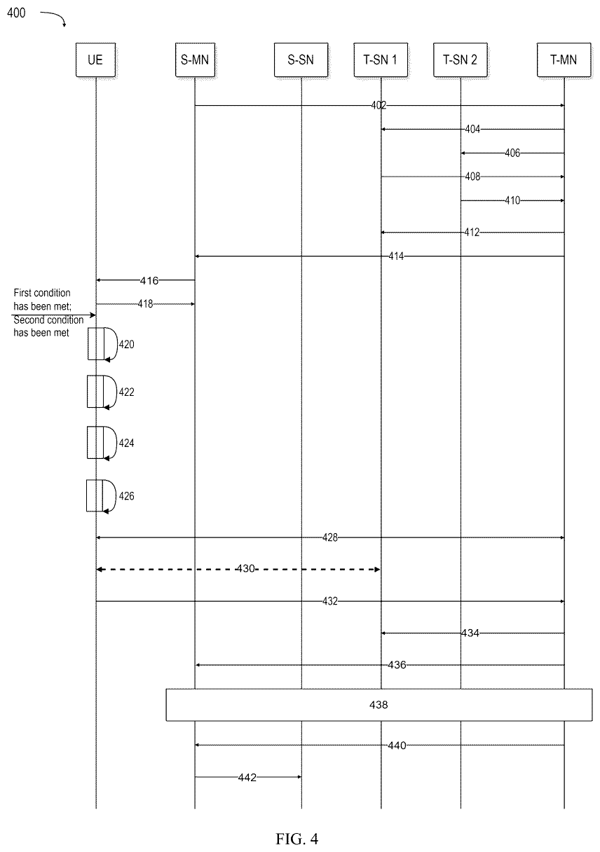

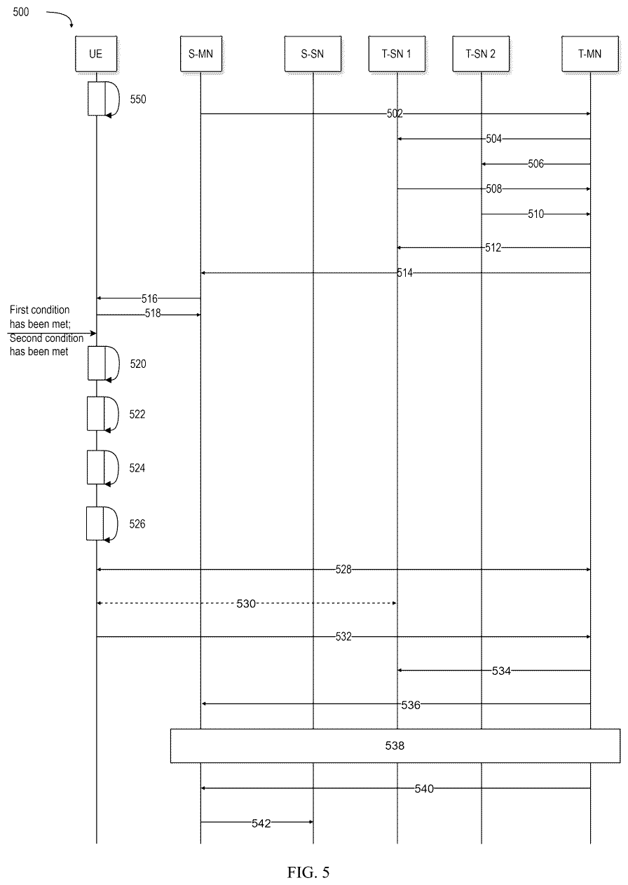

Merely for a better understanding about the above processes, two example embodiments are discussed with reference to FIG. 4 and FIG. 5.

Reference is now made to FIG. 4, which illustrates a signaling chart 400 for communication according to some example embodiments of the present disclosure.

In some example embodiments, the source MN (S-MN) may initiate 402 the conditional handover preparation procedure including MCG configuration and SCG configuration if the UE is configured with an SCG. Specifically, the S-MN may transmit an HO request to the candidate MN (T-MN).

In some example embodiments, the candidate MN may send 404, 406 the SN Addition Request message to the candidate SNs (T-SN 1 and T-SN 2) to include CPAC configuration in the CHO preparation. Within the SN Addition Request message, the candidate MN includes the CHO related information, i.e., the source MN ID and the MN UE XnAP ID in the source MN, in order to indicate that the SN Addition Preparation procedure is triggered in relation to a CHO and to enable the SN to identify requests related to the same UE.

In some example embodiments, the candidate SNs (T-SN 1 and T-SN 2) may reply 408 and 410 with the SN Addition Request Acknowledge message. Optionally, the candidate SNs (T-SN 1 and T-SN 2) may include the indication of the full or delta RRC configuration.

In some example embodiments, for the SN terminated bearers using MCG resources, the candidate MN may provide 412 Xn-U DL TNL address information in the Xn-U Address Indication message.

In some example embodiments, the candidate MN includes the MN RRC reconfiguration message (within the Handover Request Acknowledge message) to be sent to the UE in order to perform the conditional handover, and may also provide forwarding addresses to the source MN. If PDU session split is performed in the target side during handover procedure, more than one data forwarding addresses corresponding to each node are included in the Handover Request Acknowledge message. In FIG. 4, the T-MN may transmit 414 Handover Request Acknowledge message to the source MN.

In some example embodiments, the source MN may send 416 an RRC reconfiguration message to the UE, including the CHO configuration, i.e., a list of RRC reconfiguration messages and associated execution conditions, in which each RRC reconfiguration message contains an MCG configuration and possibly an SCG configuration in the RRC reconfiguration message received from the candidate SN in action 408/410.

In some example embodiments, the UE may apply the received RRC reconfiguration message, store the CHO configuration and further may reply 418 to the source MN with an RRC reconfiguration complete message.

In some example embodiments, upon receiving the RRC reconfiguration message from the source MN, the UE may decode 420 the RRC message and obtain the measurement configuration of candidate Pcells and PScells and start the measurement. While making the measurements, UE checks in the measurements of Pcells and PScells are such as 1 dB (or other defined threshold) below the corresponding condition. This is repeated when there is a measurement opportunity. If this check is satisfied, UE will extend the evaluation of PScell till the end of CHO preparation time.

In another instance, the UE may perform 422 measurement and PCell RSRP measurement shows that the CHO condition is met.

In some example embodiments, once the CHO condition is met, UE will start 424 the preparation of the RACH procedure towards PCell, while continue to measure PScell if the condition in operation 420 is met.

In some example embodiments, UE may measure 426 the PScell, and the measurement shows CPC condition is met. Then the UE may execute 428 and 430 RACH procedure towards PCell and PScell, and the UE may indicate 432 RRC Reconfiguration complete with SN RRC Reconfiguration complete to target MN, and candidate SN (T-SN 1) via candidate MN (the candidate MN transmit 434 the RRC Reconfiguration complete to the T-SN 1).

In some example embodiments, T-MN informs 436 the source MN about the success of handover. As a result, the T-MN and S-MN may perform 438 data forwarding and path switch. Finally, the T-MN inform 440 and 442 the source MN and via source MN to source SN to release UE context.

Reference is now made to FIG. 5, which illustrates a signaling chart 500 for communication according to some example embodiments of the present disclosure.

In operation, the UE is configured 550 to allow to continue measuring the target PSCell during the decoding of the target PCell configuration. Specifically, RAN4 requirements may allow the UE to continue measuring the target PSCell at least during the decoding of the target PCell configuration.

In some example embodiments, the source MN (S-MN) may start 502 the conditional handover procedure by initiating the Xn handover preparation procedure including MCG configuration and SCG configuration if the UE is configured with an SCG.

In some example embodiments, the candidate MN (T-MN) may send 504 and 506 the SN Addition Request message to the candidate SNs (T-SN 1 and T-SN 2). Within the SN Addition Request message, the candidate MN includes the CHO related information, i.e., the source MN ID and the MN UE XnAP ID in the source MN, in order to indicate that the SN Addition Preparation procedure is triggered in relation to a CHO and to enable the SN to identify requests related to the same UE.

In some example embodiments, the candidate SNs (T-SN 1 and T-SN 2) may reply 508 and 510 with the SN Addition Request Acknowledge message. Optionally, the candidate SNs (T-SN 1 and T-SN 2) may include the indication of the full or delta RRC configuration.

In some example embodiments, for the SN terminated bearers using MCG resources, the candidate MN may provide 512 Xn-U DL TNL address information in the Xn-U Address Indication message.

In some example embodiments, the candidate MN includes the MN RRC reconfiguration message (within the Handover Request Acknowledge message) to be sent to the UE in order to perform the conditional handover, and may also provide forwarding addresses to the source MN. If PDU session split is performed in the target side during handover procedure, more than one data forwarding addresses corresponding to each node are included in the Handover Request Acknowledge message. In FIG. 5, the T-MN may transmit 524 Handover Request Acknowledge message to the source MN.

In some example embodiments, the source MN may send 516 an RRC reconfiguration message to the UE, including the CHO configuration, i.e., a list of RRC reconfiguration messages and associated execution conditions, in which each RRC reconfiguration message contains an MCG configuration and possibly an SCG configuration in the RRC reconfiguration message received from the candidate SN in action 508/510.

In some example embodiments, the UE may apply the received RRC reconfiguration message, store the CHO configuration and further may reply 518 to the source MN with an RRC reconfiguration complete message.

In some example embodiments, upon receiving the RRC reconfiguration message from the source MN, UE may decode 520 the RRC message and obtain the measurement configuration of candidate PCell and PScells and start the measurement.

In another instance, UE may perform 522 measurement and PCell RSRP measurement shows that the CHO condition is met.

In some example embodiments, once the CHO condition is met, UE will start 524 the preparation of the RACH procedure towards PCell, while continue to measure PScell.

In some example embodiments, the UE may measure 526 PScell, in case the next SSB occasion for the PSCell (at least one) appears during the RRC decoding time of the target PCell. The measurement shows CPC condition is met

Then the UE may execute 528 and 530 RACH procedure towards PCell and PScell, and the UE may indicate 532 RRC Reconfiguration complete with SN RRC Reconfiguration complete to target MN, and candidate SN (T-SN 1) via candidate MN (the candidate MN transmit 534 the RRC Reconfiguration complete to the T-SN 1).

In some example embodiments, T-MN informs 536 the source MN about the success of handover. As a result, the T-MN and S-MN may perform 538 data forwarding and path switch. Finally, the T-MN inform 540 and 542 the source MN and via source MN to source SN to release UE context.

In summary, if the RSRP value of the SSB measurement of the PScell is 1 dB (or other threshold) below the CPC condition defined in an RRC reconfiguration message, the evaluation of PScell in the next measurement opportunity will be extended till the end of CHO preparation time.

### EXAMPLE METHODS

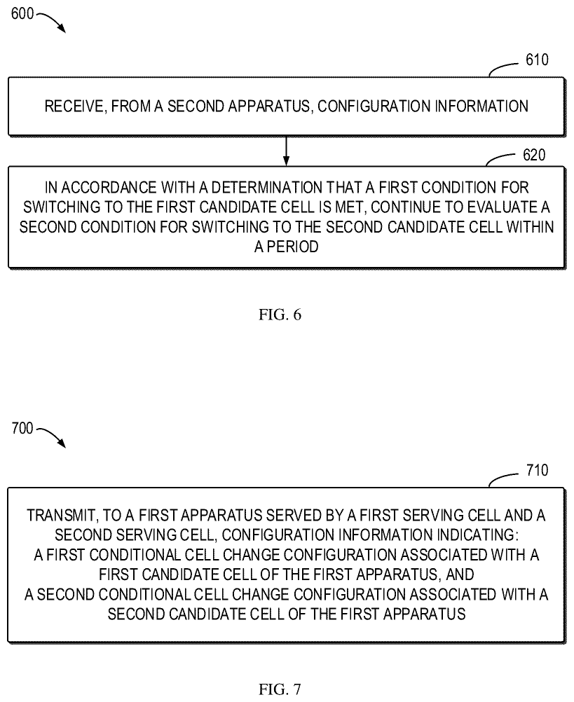

FIG. 6 shows a flowchart of an example method 600 implemented at a first apparatus in accordance with some example embodiments of the present disclosure. For the purpose of discussion, the method 600 will be described from the perspective of the first apparatus 110 in FIG. 1.

At block 610, the first apparatus receives, from a second apparatus, configuration information indicating: a first conditional cell change configuration associated with a first candidate cell of the first apparatus, and a second conditional cell change configuration associated with a second candidate cell of the first apparatus.

At block 620, in accordance with a determination that a first condition for switching to the first candidate cell is met, the first apparatus continues to evaluate a second condition for switching to the second candidate cell within a period, the first apparatus is served by a first serving cell and a second serving cell.

In some example embodiments, the first apparatus, based on at least one of the following, is configured to allow to continue to evaluate the second condition after the first condition is met: a default configuration rule, or an indication received from a second apparatus that serves the first apparatus, the indication indicating that the first apparatus is allowed to continue to evaluate the second condition after the first condition is met.

In some example embodiments, in accordance with a determination that the second condition for switching to the second candidate cell is met within the period, the first apparatus triggers a switch to the first and second candidate cells.

In some example embodiments, in response to the second condition having not been met after the period, the first apparatus switches to the first candidate cell.

In some example embodiments, the first apparatus determines a communication quality of the second serving candidate cell of the first apparatus; and in response to a different between the communication quality and a communication quality required by the second condition of the second serving cell being below a threshold quality, continues to evaluate the second condition.

In some example embodiments, the threshold quality is defined as a default value or configured by a second apparatus that serves the first apparatus.

In some example embodiments, a time length of the period is associated with at least one of the following: a first time length required for decoding a handover configuration used for switching to the first cell, or a second time length corresponding to an execution preparation time length for switching to the first cell.

In some example embodiments, the period is defined as a default value or configured by a second apparatus that serves the first apparatus.

In some example embodiments, the first apparatus may continue to evaluate the second condition for switching to the second candidate cell within the period before an interruption caused by performing a Physical Random Access Channel (PRACH) transmission.

In some example embodiments, the first serving cell is a primary cell (PCell), the second serving cell is a primary secondary cell (PSCell), and the first candidate cell is a candidate PCell and the second candidate cell is a candidate PSCell.

In some example embodiments, the first apparatus is a terminal device.

FIG. 7 shows a flowchart of an example method 700 implemented at a second apparatus in accordance with some example embodiments of the present disclosure. For the purpose of discussion, the method 700 will be described from the perspective of the second apparatus (such as, the master node 120-1 or the secondary node 120-2 in FIG. 1).

At block 710, apparatus transmits, to a first apparatus served by a first serving cell and a second serving cell, configuration information indicating: a first conditional cell change configuration associated with a first candidate cell of the first apparatus, and a second conditional cell change configuration associated with a second candidate cell of the first apparatus, the configuration information further indicates at least one of the following: an indication indicating that the first apparatus is allowed to continue to evaluate a second condition after a first condition is met, the first condition being used for switching to the first candidate cell and the second condition being used for switching to the second candidate cell, a time length of a period, wherein the first apparatus continues to evaluate the second condition within the period after the first condition is met, or a threshold quality, wherein the first apparatus continues to evaluate the second condition within the period after the first condition is met if a communication quality of the second serving cell is below the threshold quality.

In some example embodiments, the first serving cell is a primary cell (PCell), the second serving cell is a primary secondary cell (PSCell), and the first candidate cell is a candidate PCell and the second candidate cell is a candidate PSCell.

In some example embodiments, the first apparatus is a terminal device and the second apparatus is a network device.

### EXAMPLE APPARATUS, DEVICE AND MEDIUM

In some example embodiments, a first apparatus capable of performing any of the method 600 (for example, the first apparatus 110 in FIG. 1) may comprise means for performing the respective operations of the method 600. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, configuration information indicating: a first conditional cell change configuration associated with a first candidate cell of the first apparatus, and a second conditional cell change configuration associated with a second candidate cell of the first apparatus; and means for in accordance with a determination that a first condition for switching to the first candidate cell is met, continuing to evaluate a second condition for switching to the second candidate cell within a period, wherein the first apparatus is served by a first serving cell and a second serving cell.

In some example embodiments, the first apparatus, based on at least one of the following, is configured to allow to continue to evaluate the second condition after the first condition is met: a default configuration rule, or an indication received from a second apparatus that serves the first apparatus, the indication indicating that the first apparatus is allowed to continue to evaluate the second condition after the first condition is met.

In some example embodiments, the first apparatus further comprises: means for in accordance with a determination that the second condition for switching to the second candidate cell is met within the period, triggering a switch to the first and second candidate cells.

In some example embodiments, the first apparatus further comprises: means for in response to the second condition having not been met after the period, switching to the first candidate cell.

In some example embodiments, the first apparatus further comprises: means for determining a communication quality of the second serving candidate cell of the first apparatus; and means for in response to a different between the communication quality and a communication quality required by the second condition of the second serving cell being below a threshold quality, continuing to evaluate the second condition.

In some example embodiments, the threshold quality is defined as a default value or configured by a second apparatus that serves the first apparatus.

In some example embodiments, a time length of the period is associated with at least one of the following: a first time length required for decoding a handover configuration used for switching to the first cell, or a second time length corresponding to an execution preparation time length for switching to the first cell.

In some example embodiments, the period is defined as a default value or configured by a second apparatus that serves the first apparatus.

In some example embodiments, the first apparatus further comprises: means for continuing to evaluate the second condition for switching to the second candidate cell within the period before an interruption caused by performing a Physical Random Access Channel (PRACH) transmission.

In some example embodiments, the first serving cell is a primary cell (PCell), the second serving cell is a primary secondary cell (PSCell), and the first candidate cell is a candidate PCell and the second candidate cell is a candidate PSCell.

In some example embodiments, the first apparatus is a terminal device.

In some example embodiments, the first apparatus further comprises means for performing other operations in some example embodiments of the method 600 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 700 (for example, the second apparatus, such as, the master node 120-1 or the secondary node 120-2 in FIG. 1) may comprise means for performing the respective operations of the method 700. The means may be implemented in any suitable form. For example, the means may be implemented in a circuitry or software module. The second apparatus may be implemented as or included in the second apparatus, such as, the master node 120-1 or the secondary node 120-2 in FIG. 1.

In some example embodiments, the second apparatus comprises means for transmitting, to a first apparatus served by a first serving cell and a second serving cell, configuration information indicating: a first conditional cell change configuration associated with a first candidate cell of the first apparatus, and a second conditional cell change configuration associated with a second candidate cell of the first apparatus, wherein the configuration information further indicates at least one of the following: an indication indicating that the first apparatus is allowed to continue to evaluate a second condition after a first condition is met, the first condition being used for switching to the first candidate cell and the second condition being used for switching to the second candidate cell, a time length of a period, wherein the first apparatus continues to evaluate the second condition within the period after the first condition is met, or a threshold quality, wherein the first apparatus continues to evaluate the second condition within the period after the first condition is met if a communication quality of the second serving cell is below the threshold quality.

In some example embodiments, the first serving cell is a primary cell (PCell), the second serving cell is a primary secondary cell (PSCell), and the first candidate cell is a candidate PCell and the second candidate cell is a candidate PSCell.

In some example embodiments, the first apparatus is a terminal device and the second apparatus is a network device.

In some example embodiments, the second apparatus further comprises means for performing other operations in some example embodiments of the method 700 or the second apparatus. In some example embodiments, the means comprises at least one processor; and at least one memory storing instructions that, when executed by the at least one processor, cause the performance of the second apparatus.

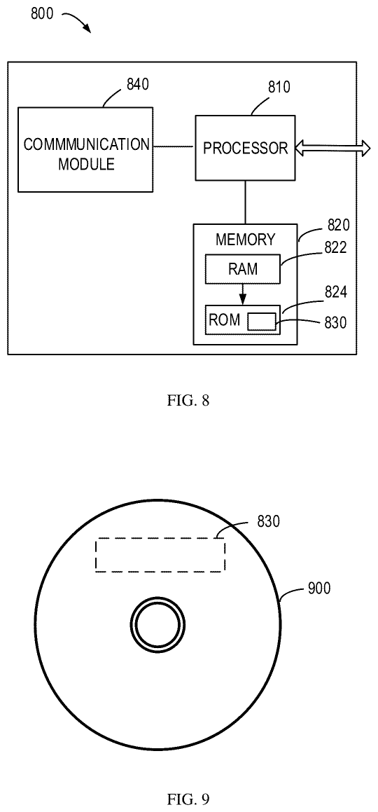

FIG. 8 is a simplified block diagram of a device 800 that is suitable for implementing example embodiments of the present disclosure. The device 800 may be provided to implement a communication device, for example, the first device 110 or the second apparatus as shown in FIG. 1. As shown, the device 800 includes one or more processors 810, one or more memories 820 coupled to the processor 810, and one or more communication modules 840 coupled to the processor 810.

The communication module 840 is for bidirectional communications. The communication module 840 has one or more communication interfaces to facilitate communication with one or more other modules or devices. The communication interfaces may represent any interface that is necessary for communication with other network elements. In some example embodiments, the communication module 840 may include at least one antenna.

The processor 810 may be of any type suitable to the local technical network and may include one or more of the following: general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The memory 820 may include one or more non-volatile memories and one or more volatile memories. Examples of the non-volatile memories include, but are not limited to, a Read Only Memory (ROM) 824, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 822 and other volatile memories that will not last in the power-down duration.

A computer program 830 includes computer executable instructions that are executed by the associated processor 810. The instructions of the program 830 may include instructions for performing operations/acts of some example embodiments of the present disclosure. The program 830 may be stored in the memory, e.g., the ROM 824. The processor 810 may perform any suitable actions and processing by loading the program 830 into the RAM 822.

The example embodiments of the present disclosure may be implemented by means of the program 830 so that the device 800 may perform any process of the disclosure as discussed with reference to FIG. 3A to FIG. 7. The example embodiments of the present disclosure may also be implemented by hardware or by a combination of software and hardware.

In some example embodiments, the program 830 may be tangibly contained in a computer readable medium which may be included in the device 800 (such as in the memory 820) or other storage devices that are accessible by the device 800. The device 800 may load the program 830 from the computer readable medium to the RAM 822 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. BBBB shows an example of the computer readable medium BBBB00 which may be in form of CD, DVD or other optical storage disk. The computer readable medium BBBB00 has the program 830 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1.-17. (canceled)

18. A first apparatus comprising:
at least one processor; and
at least one memory storing instructions that, when executed by the at least one processor, cause the first apparatus at least to:
receive, from a second apparatus, configuration information indicating:
a first conditional cell change configuration associated with a first candidate cell of the first apparatus, and
a second conditional cell change configuration associated with a second candidate cell of the first apparatus; and
in accordance with a determination that a first condition for switching to the first candidate cell is met, continue to evaluate a second condition for switching to the second candidate cell within a period, wherein a time length of the period is associated with the following: a first time length required for decoding a handover configuration used for switching to the first candidate cell, and a second time length corresponding to an execution preparation time length for switching to the first candidate cell;
continue to evaluate the second condition for switching to the second candidate cell within the period before an interruption caused by performing a Physical Random Access Channel (PRACH) transmission;
determine a communication quality of the second candidate cell;
in response to a difference between the communication quality and a communication quality required by the second condition being below a threshold quality, continue to evaluate the second condition; and
in accordance with a determination that the second condition for switching to the second candidate cell is met within the period, trigger a switch to the first and second candidate cells, wherein the first apparatus is served by a first serving cell and a second serving cell.

19. The first apparatus of claim 18, wherein the first apparatus is configured to allow to continue to evaluate the second condition after an indication is received from a second apparatus that serves the first apparatus, the indication indicating that the first apparatus is allowed to continue to evaluate the second condition after the first condition is met.

20. The first apparatus of claim 19, wherein the threshold quality is configured by a second apparatus that serves the first apparatus.

21. The first apparatus of claim 20, wherein the period is configured by a second apparatus that serves the first apparatus.

22. The first apparatus of claim 21, wherein the first serving cell is a primary cell (PCell), and the second serving cell is a primary secondary cell (PSCell).

23. The first apparatus of claim 22, wherein the first candidate cell is a candidate PCell and the second candidate cell is a candidate PSCell.

24. The first apparatus of claim 23, wherein the first apparatus is a terminal device.

25. A system comprising:
a first apparatus:
at least one processor; and
at least one memory storing instructions that, when executed by the at least one processor, cause the first apparatus at least to:
receive, from a second apparatus, configuration information indicating:
a first conditional cell change configuration associated with a first candidate cell of the first apparatus, and
a second conditional cell change configuration associated with a second candidate cell of the first apparatus; and
in accordance with a determination that a first condition for switching to the first candidate cell is met, continue to evaluate a second condition for switching to the second candidate cell within a period, wherein a time length of the period is associated with the following: a first time length required for decoding a handover configuration used for switching to the first candidate cell, and a second time length corresponding to an execution preparation time length for switching to the first candidate cell;
continue to evaluate the second condition for switching to the second candidate cell within the period before an interruption caused by performing a Physical Random Access Channel (PRACH) transmission;
determine a communication quality of the second candidate cell;
in response to a difference between the communication quality and a communication quality required by the second condition being below a threshold quality, continue to evaluate the second condition; and
in accordance with a determination that the second condition for switching to the second candidate cell is met within the period, trigger a switch to the first and second candidate cells, wherein the first apparatus is served by a first serving cell and a second serving cell.

26. The system of claim 25, wherein the first apparatus is configured to allow to continue to evaluate the second condition after an indication is received from a second apparatus that serves the first apparatus, the indication indicating that the first apparatus is allowed to continue to evaluate the second condition after the first condition is met.

27. The system of claim 26, wherein the threshold quality is configured by a second apparatus that serves the first apparatus.

28. The system of claim 27, wherein the period is configured by a second apparatus that serves the first apparatus.

29. The system of claim 28, wherein the first serving cell is a primary cell (PCell), and the second serving cell is a primary secondary cell (PSCell).

30. The system of claim 29, wherein the first candidate cell is a candidate PCell and the second candidate cell is a candidate PSCell.

31. The system of claim 30, wherein the first apparatus is a terminal device.

32. A method comprising:
receiving, by a first apparatus from a second apparatus, configuration information indicating:
a first conditional cell change configuration associated with a first candidate cell of the first apparatus, and
a second conditional cell change configuration associated with a second candidate cell of the first apparatus; and
in accordance with a determination that a first condition for switching to the first candidate cell is met, continuing to evaluate a second condition for switching to the second candidate cell within a period, wherein a time length of the period is associated with the following: a first time length required for decoding a handover configuration used for switching to the first candidate cell, and a second time length corresponding to an execution preparation time length for switching to the first candidate cell;
continuing to evaluate the second condition for switching to the second candidate cell within the period before an interruption caused by performing a Physical Random Access Channel (PRACH) transmission;
determining a communication quality of the second candidate cell;
in response to a difference between the communication quality and a communication quality required by the second condition being below a threshold quality, continuing to evaluate the second condition; and
in accordance with a determination that the second condition for switching to the second candidate cell is met within the period, triggering a switch to the first and second candidate cells, wherein the first apparatus is served by a first serving cell and a second serving cell.

33. The method of claim 32, wherein the first apparatus is configured to allow to continue to evaluate the second condition after an indication is received from a second apparatus that serves the first apparatus, the indication indicating that the first apparatus is allowed to continue to evaluate the second condition after the first condition is met.

34. The method of claim 33, wherein the threshold quality is configured by a second apparatus that serves the first apparatus.

35. The method of claim 34, wherein the period is configured by a second apparatus that serves the first apparatus.

36. The method of claim 35, wherein the first serving cell is a primary cell (PCell), and the second serving cell is a primary secondary cell (PSCell).

37. The method of claim 36, wherein the first candidate cell is a candidate PCell and the second candidate cell is a candidate PSCell, and wherein the first apparatus is a terminal device.
